(19) United States
(12) Patent Application Publication
(10) Pub. No.: US 2018/0171122 A1
(43) Pub. Date: Jun. 21, 2018

(54) RUBBER COMPOSITION

(71) Applicant: TOYO TIRE & RUBBER CO., LTD., Itami-shi (JP)

(72) Inventor: Takashi Yuri, Itami-shi (JP)

(73) Assignee: TOYO TIRE & RUBBER CO., LTD., Itami-shi (JP)

(21) Appl. No.: 15/788,017

(22) Filed: Oct. 19, 2017

(30) Foreign Application Priority Data
Dec. 15, 2016 (JP) 2016-243047

(51) Int. Cl. C08L 9/06; C08L 9/00; C08L 7/00

(52) U.S. Cl. CPC C08L 9/06; C08L 7/00; C08L 9/00

(57) ABSTRACT

A rubber composition, comprising one or more rubber components, and an oil of a plant in the family Euphorbiaceae in an amount of 1 to 60 parts by mass for the entire amount of the rubber component(s) when the entire amount is regarded as 100 parts by mass. It is preferred that the plant oil is an oil originating from an inedible resource and comprising an unsaturated fatty acid in a proportion of 50% by mass or more of the plant oil.

### BACKGROUND OF THE INVENTION

### Field of the Invention

The present invention relates to a rubber composition excellent in workability. This rubber composition is useful as a raw material for a vulcanized rubber for tires that is excellent in low exothermicity.

### Description of the Related Art

In a rubber composition which is a raw material for a tread or some other member as a constituent of a tire, a process oil such as aroma oil has been conventionally used as a softener. However, a vulcanized rubber into which the process oil is blended tends to become high in exothermicity. As a result, when the vulcanized rubber is used for, e.g., a tread, there is caused a problem that the fuel efficiency of the tire is deteriorated by a deterioration of the tire in rolling resistance which follows a hysteresis loss deterioration of the rubber. Moreover, it is feared that aroma oil or the like has carcinogenicity because of its polycyclic aromatic component. In recent years, instead of aroma oil, a new softener has been required in consonance with a rise in awareness of environmental issues.

Patent Document 1 listed below describes a technique of blending a naturally-derived polyphenol into a rubber composition to decrease the hardening of the composition which follows the ageing of the composition.

Patent Document 2 described below describes a technique of blending, into a rubber composition, a fatty acid obtained from plant fats and oils having a iodine value of 80 or more to provide a tread for tires which is controlled at a high level about the energy loss thereof in a wide frequency range, and which has a high frictional force, particularly, in a wet road surface.

### PRIOR ART DOCUMENTS

### Patent Documents

Patent Document 1: JP-A-2010-132864

Patent Document 2: JP-A-2005-213415

However, the present inventors have made eager investigations to make it evident that when the rubber composition of each of the above-mentioned precedent techniques is made into a vulcanized rubber, there remains, in the techniques, a room to be further improved about the low exothermicity of the resultant tires. Additionally, it has been made evident that there remains a room to be further improved also about the workability of the rubber composition.

### SUMMARY OF THE INVENTION

In the light of the actual situation, the present invention has been made, and an object thereof is to provide a rubber composition which can be a raw material for vulcanized rubbers improving the low exothermicity of tires and which is excellent in workability.

The object can be attained by the present invention, which is a rubber composition including one or more rubber components, and an oil of a plant in the family Euphorbiaceae in an amount of 1 to 60 parts by mass for the entire amount of the rubber component(s) when the entire amount is regarded as 100 parts by mass. The plant oil is preferably an oil originating from an inedible resource and including an unsaturated fatty acid in a proportion of 50% by mass or more of the plant oil. The rubber composition according to the present invention includes the above-specified plant oil, and this plant oil is excellent in compatibility with rubber components, particularly, a diene rubber. As a result, the plant oil can improve the rubber composition in workability, and can further restrain the resultant vulcanized rubber from being deteriorated in physical properties, for example, low exothermicity.

It is preferred that the rubber component include one or more softener components, and include the plant oil in a proportion of 10% by mass or more of the whole of the softener component(s). The plant in the family Euphorbiaceae is preferably at least one selected from the group consisting of Vernicia cordata, Aleurites fordii, Jatropha curcas, and Para rubber tree. The rubber composition preferably includes, as the rubber component(s), natural rubber in an amount of 5 to 100 parts by mass. According to these embodiments of the present invention, the workability of the rubber composition and the low exothermicity of the vulcanized rubber can be improved with a better balance.

### DETAILED DESCRIPTION OF THE PREFERRED EMBODIMENTS

The rubber composition according to the present invention includes an oil of a plant in the family Euphorbiaceae. The wording “oil of a plant in the family Euphorbiacea” denotes an oily component obtained using, as a raw material, a seed of the plant in the family Euphorbiaceae.

Plants in the family Euphorbiaceae are plants each originating from an inedible resource, and can be classified into the subfamily Acalypha, the subfamily Croton tiglium, the subfamily Euphorbia and other subfamilies. The subfamily Croton tiglium also includes the genus Aleurites, and the genus Hevea. In the case of using, out of plants in the family Euphorbiacea, at least one selected from the group consisting of Vernicia cordata, Aleurites fordii, Jatropha curcas, and Para rubber tree in the present invention, the workability of the rubber composition and the low exothermicity of the resultant vulcanized rubber can be favorably improved with a better balance. In the case of using, out of respective oils of plants in the family Euphorbiacea, a plant oil containing an unsaturated fatty acid in a proportion of 50% by mass or more of the plant oil, the oil is excellent in compatibility with rubber components, particularly, a diene rubber; thus, when the rubber composition including this oil is made into a vulcanized rubber, the vulcanized rubber can be favorably restrained from being deteriorated in physical properties such as low exothermicity.

The rubber composition includes the oil of the plant in the family Euphorbiaceae in an amount preferably from 1 to 60 parts, more preferably from 1 to 30 parts by mass for the entire amount of one or more rubber components of the composition when this entire amount is regarded as 100 parts by mass. When the rubber composition according to the present invention includes one or more softener components and includes the plant oil in a proportion of 10% by mass or more of the whole of the softener component(s), an improvement is made in the compatibility of the softener(s) with the rubber component(s), in particular, the component that is a diene rubber. Thus, this case is preferred. The plant oil is included in the rubber composition more preferably in a proportion of 30% by mass or more. The definition of the softener(s) in the present invention will be described later.

The rubber composition according to the present invention includes, as the rubber component(s), one or more diene rubbers. Examples of the diene rubber(s) include natural rubber (NR), polyisoprene rubber (IR), polybutadiene rubber (BR), polystyrene-butadiene rubber (SBR), chloroprene rubber (CR), and nitrile rubber (NBR). As the need arises, the following are also preferably usable: rubbers each obtained by modifying a terminal of any one of these rubbers (for example, terminal-modified SBR); and rubbers each obtained by modifying any one of these rubbers to give a desired property to the rubber (for example, modified NR). Out of these rubbers, NR is preferably used, which is excellent in compatibility with an oil of a plant in the family Euphorbiaceae, particularly, Para rubber tree. In the case of the use of NR, the rubber composition includes NR preferably in an amount of 5 to 100 parts by mass when the entire amount of the rubber component(s) is regarded as 100 parts by mass.

The rubber composition according to the present invention preferably includes silica as a filler. The species of the silica may be a species usable for ordinary rubber-reinforcement, such as wet silica, dry silica, sol-gel silica or surface-treated silica. Out of these species, wet silica is preferred. The blend amount of the silica is preferably from 20 to 120 parts by mass, more preferably from 40 to 100 parts by mass for the entire amount of the rubber component(s) when the entire amount is regarded as 100 parts by mass.

The rubber composition of the present invention may include a silane coupling agent. The silane coupling agent is not particularly limited as far as the agent is a silane coupling agent containing, in the molecule thereof, sulfur. In the rubber composition, various silane coupling agents are usable which are each blended, together with silica. Examples thereof include sulfide silanes such as bis(3-triethoxysilylpropyl) tetrasulfide (for example, “Si69” manufactured by Degussa AG), bis(3-triethoxysilylpropyl) disulfide (for example, “Si75” manufactured by Degussa AG, bis(2-triethoxysilylethyl) tetrasulfide, bis(4-triethoxysilylbutyl) disulfide, bis(3-trimethoxysilylpropyl) tetrasulfide, and bis(2-trimethoxysilylethyl)disulfide; mercaptosilanes such as γ-mercaptopropyltrimethoxysilane, γ-mercaptopropyltriethoxysilane, mercaptopropylmethyldimethoxysilane, mercaptopropyldimethylmethoxysilane, and mercaptoethyltriethoxylsilane; and protected mercaptosilanes such as 3-octanoylthio-1-propyltriethoxysilane, and 3-propionylthiopropyltrimethoxysilane. The blend amount of the silane coupling agent is preferably form 1 to 20 parts by mass, more preferably from 3 to 10 parts by mass for 100 parts by mass of the silica.

In addition to the diene rubber(s), plant oil of the family Euphorbiaceae, silica and silane coupling agent each detailed above, the following may be blended into the rubber composition according to the present invention: carbon black, vulcanization blending agents, an antiaging agent, zinc oxide, stearic acid, softeners such as wax and oil, a processing aid, and others.

The species of the carbon black may be any carbon black species used in an ordinary rubber industry, such as SAF, ISAF, HAF, FEF or GPF, or may be an electroconductive carbon black such as acetylene black or ketjen black.

The carbon black is blended into the rubber composition according to the present invention in an amount preferably from 1 to 80 parts by mass, more preferably from 5 to 60 parts by mass for 100 parts by mass of the diene rubber(s).

In the present invention, examples of the softeners include, besides any plant oil of the family Euphorbiaceae, oils originating from edible resources, such as olive oil, cottonseed oil, rapeseed oil, corn oil, sesame oil, soybean oil, and linseed oil; and process oils. As described above, however, in the present invention, it is preferred that the blend amount of oils other than any plant oil of the family Euphorbiaceae be small.

The antiaging agent may be an antiaging agent used ordinarily for rubbers, examples thereof including aromatic amine type, amine-ketone type, monophenolic type, bisphenolic type, polyphenolic type, dithiocarbamate type, and thiourea type antiaging agents. Such antiaging agents may be used singly or in the form of an appropriate mixture of two or more thereof. The antiaging agent content is preferably from 0.1 to 10 parts by mass for 100 parts by mass of the rubber component(s).

Examples of the vulcanization blending agents include vulcanizing agents such as sulfur and organic peroxides, a vulcanization accelerator, a vulcanization accelerator aid, and a vulcanization retardant.

The species of the sulfur as one of the vulcanization blending agents may be any ordinary sulfur species for rubbers. Examples thereof include powdery sulfur, precipitated sulfur, insoluble sulfur, and highly dispersible sulfur. When physical properties, the durability and others of the resultant vulcanized rubber are considered, the blend amount of the sulfur is preferably from 0.1 to 10 parts by mass for 100 parts by mass of the rubber component(s), the amount being in terms of the sulfur content.

The vulcanization accelerator may be a vulcanization accelerator used ordinarily for rubber-vulcanization. Examples thereof include sulfenamide type, thiuram type, thiazole type, thiourea type, guanidine type, and dithiocarbamate type vulcanization promoters. Such vulcanization accelerators may be used singly or in the form of an appropriate mixture of two or more thereof. The blend amount of the vulcanization accelerator(s) is preferably from 0.1 to 10 parts by mass for 100 parts by mass of the rubber component(s).

The rubber composition according to the present invention can be yielded by using a kneading machine used in an ordinary rubber industry, such as a Banbury mixer, a kneader or a roll, to mix/knead the diene rubber(s), plant oil of the family Euphorbiaceae, silica and silane coupling agent each detailed above, and optional components that may be optionally used, which are carbon black, vulcanization blending agents, an antiaging agent, zinc oxide, stearic acid, softeners such as wax and oil, a processing aid and others.

The method for blending each component with each other is not particularly limited, and may be, for example, a method of mixing/kneading, in advance, blending components other than the vulcanization blending agents such as the sulfur-containing vulcanizing agent and the vulcanization accelerator to prepare a masterbatch, adding the remaining components thereto, and further mixing/kneading the entire components; a method of adding each component in any order, and then mixing/kneading the components; or a method of adding the entire components simultaneously and mixing/kneading the components.

### EXAMPLES

Hereinafter, a description will be made about examples demonstrating the subject matter and the advantageous effects of the present invention specifically, and others. In evaluating-items in the examples and comparative examples, evaluations were made on the basis of evaluation conditions described below about rubber samples each yielded by heating and vulcanizing each rubber composition at 150° C. for 30 minutes.

### (1) Low Exothermicity (Exothermic Property)

A viscoelasticity tester manufactured by Toyo Seiki Seisaku-sho, Ltd. is used to measure the loss tangent tan δ of one of the samples of each of the above-mentioned examples at a frequency of 10 Hz, a static strain of 10%, a dynamic strain of 1% and a temperature of 60° C. About each of Examples 1 to 6, and Comparative Example 2, the measured value is evaluated as an index relative to the value of Comparative Example 1, this value being regarded as 100. About each of Examples 7 to 9, and Comparative Example 4, the measured value is evaluated as an index relative to the value of Comparative Example 3, this value being regarded as 100. About each of Examples 10 to 12, and Comparative Example 6, the measured value is evaluated as an index relative to the value of Comparative Example 5, this value being regarded as 100. It is meant that as the resultant numerical value is lower, the rubber composition is better in low exothermicity.

### (2) Workability

In accordance with JIS K6300, a rotorless Mooney measuring instrument manufactured by Toyo Seiki Seisaku-sho, Ltd. is used to heat the unvulcanized rubber of each of the above-mentioned examples at 100° C. for 1 minute by remaining heat, and measure, after 4 minutes, the torque value thereof in the unit of Mooney. About each of Examples 1 to 6, and Comparative Example 2, the measured value is evaluated as an index relative to the value of Comparative Example 1, this value being regarded as 100. About each of Examples 7 to 9, and Comparative Example 4, the measured value is evaluated as an index relative to the value of Comparative Example 3, this value being regarded as 100. About each of Examples 10 to 12, and Comparative Example 6, the measured value is evaluated as an index relative to the value of Comparative Example 5, this value being regarded as 100. It is meant that as the resultant numerical value is lower, the rubber composition is better in workability.

### (Preparation of Each Rubber Composition)

In a blend formulation in Tables 1 to 3, a rubber composition of each of Examples 1 to 12 and Comparative Examples 1 to 6 was formulated, and mixed/kneaded by means of an ordinary Bunbury mixer to prepare a rubber composition. The blending agents shown in Tables 1 to 3 are as follows (in Table 1, the blend amount of each of the blending agents is represented as a numerical value (in the unit of part(s) by mass) that is relative to 100 parts by mass of one or more rubber components).

a) Softener Components
Process oil: “PROCESS P200”, manufactured by Jomo Sun-Energy Co., Ltd
Palm oil (edible plant oil obtained from oil palm): Oil manufactured by Yamakei Sangyo Ltd.; unsaturated fatty acid content by percentage: 46% by weight
Vernicia cordata seed oil: “KIRIYU” manufactured by Yamakei Sangyo Ltd.; unsaturated fatty acid content by percentage: 82% by weight
Jatropha curcas seed oil: Oil manufactured by Nippon Biodiesel Fuel; unsaturated fatty acid content by percentage: 78% by weight
Para rubber tree seed oil: Oil manufactured by Viet Delta Corporation; unsaturated fatty acid content by percentage: 55% by weight

b) Rubber Components:
SBR 1 (terminal-unmodified SBR): “VSL5025-0HM” manufactured by LANXESS AG
SBR 2 (terminal-modified SSBR): “HPR350” manufactured by JSR Corporation
NR: RSS #3
BR: “BR150B”, manufactured by Ube Industries, Ltd.;

c) Silica: “NIPSIL AQ” (manufactured by Tosoh silica Corporation)

d) Carbon black: “DIABLACK N341” (manufactured by Mitsubishi Chemical Corporation)

e) Silane coupling agent: “Si 69” (manufactured by Evonik Degussa GmbH)

f) Zinc flower: “Zinc flower No. 1” (manufactured by Mitsui Mining & Smelting Co., Ltd.)

g) Antiaging agent: “ANTIGEN 6C”, manufactured by Sumitomo Chemical Co., Ltd.

h) Stearic acid: “LUNAC S-20” (manufactured by Kao Corporation)

i) Wax: “OZOACE 0355” (manufactured by Nippon Seiro Co., Ltd.)

j) Sulfur: “5%-Oil-blended powdery sulfur” (manufactured by Tsurumi Chemical Industry Co., Ltd.)

k) Vulcanization accelerators:
Vulcanization accelerator 1: “SOXINOL CZ” (manufactured by Sumitomo Chemical Co., Ltd.)
Vulcanization accelerator 2: “NOCCELLAR D”, manufactured by Ouchi Shinko Chemical Industrial Co., Ltd.

TABLE 1

| | Comparative | Comparative | Example | Example | Example | Example | Example | Example |
|---|---|---|---|---|---|---|---|---|
| | Example 1 | Example 2 | 1 | 2 | 3 | 4 | 5 | 6 |
| Process oil | 40 | | | | | 20 | | |
| Palm oil | | 40 | | | | | | |
| Vernicia cordata seed oil | | | 40 | | | | | |
| Jatropha curcas seed oil | | | | 40 | | | | |
| Para rubber tree seed oil | | | | | 40 | 20 | 40 | 40 |
| SBR (1) | 70 | 70 | 70 | 70 | 70 | 70 | | 70 |
| SBR (2) | | | | | | | 70 | |
| Natural rubber | 30 | 30 | 30 | 30 | 30 | 30 | 30 | 30 |
| BR | | | | | | | | |
| Silica | 70 | 70 | 70 | 70 | 70 | 70 | 70 | 40 |
| Coupling agent | 7 | 7 | 7 | 7 | 7 | 7 | 7 | 7 |
| CB | 10 | 10 | 10 | 10 | 10 | 10 | 10 | 40 |
| Silane coupling agent | 7 | 7 | 7 | 7 | 7 | 7 | 7 | 3.5 |
| Zinc Flower | 3.0 | 3.0 | 3.0 | 3.0 | 3.0 | 3.0 | 3.0 | 3.0 |
| Antiaging agent | 2.0 | 2.0 | 2.0 | 2.0 | 2.0 | 2.0 | 2.0 | 2.0 |
| Stearic acid | 2.0 | 2.0 | 2.0 | 2.0 | 2.0 | 2.0 | 2.0 | 2.0 |
| Wax | 2.0 | 2.0 | 2.0 | 2.0 | 2.0 | 2.0 | 2.0 | 2.0 |
| Sulfur | 1.5 | 1.5 | 1.5 | 1.5 | 1.5 | 1.5 | 1.5 | 1.5 |
| Vulcanization accelerator | 1.8 | 1.8 | 1.8 | 1.8 | 1.8 | 1.8 | 1.8 | 1.8 |
| Workability | 100 | 98 | 92 | 90 | 95 | 90 | 98 | 86 |
| Exothermic property | 100 | 98 | 92 | 90 | 93 | 95 | 70 | 88 |

TABLE 2

| Comparative | Comparative | | | |
|---|---|---|---|---|
| Example 3 | Example 4 | Example 7 | Example 8 | Example 9 |
| 10 | | | | |
| | 10 | | | |
| | | 10 | | |
| | | | 10 | |
| | | | | 10 |
| 40 | 40 | 40 | 40 | 40 |
| 60 | 60 | 60 | 60 | 60 |
| 5 | 5 | 5 | 5 | 5 |
| 7 | 7 | 7 | 7 | 7 |
| 50 | 50 | 50 | 50 | 50 |
| 0.5 | 0.5 | 0.5 | 0.5 | 0.5 |
| 3.0 | 3.0 | 3.0 | 3.0 | 3.0 |
| 4.0 | 4.0 | 4.0 | 4.0 | 4.0 |
| 2.0 | 2.0 | 2.0 | 2.0 | 2.0 |
| 2.0 | 2.0 | 2.0 | 2.0 | 2.0 |
| 2.0 | 2.0 | 2.0 | 2.0 | 2.0 |
| 0.7 | 0.7 | 0.7 | 0.7 | 0.7 |
| 100 | 98 | 94 | 95 | 96 |
| 100 | 100 | 93 | 92 | 93 |

TABLE 3

| Comparative | Comparative | | | |
|---|---|---|---|---|
| Example 5 | Example 6 | Example 10 | Example 11 | Example 12 |
| 10 | | | | |
| | 10 | | | |
| | | 10 | | |
| | | | 10 | |
| | | | | 10 |
| 100 | 100 | 100 | 100 | 100 |
| 5 | 5 | 5 | 5 | 5 |
| 7 | 7 | 7 | 7 | 7 |
| 50 | 50 | 50 | 50 | 50 |
| 0.5 | 0.5 | 0.5 | 0.5 | 0.5 |
| 3.0 | 3.0 | 3.0 | 3.0 | 3.0 |
| 2.0 | 2.0 | 2.0 | 2.0 | 2.0 |
| 2.0 | 2.0 | 2.0 | 2.0 | 2.0 |
| 2.0 | 2.0 | 2.0 | 2.0 | 2.0 |
| 2.0 | 2.0 | 2.0 | 2.0 | 2.0 |
| 1.0 | 1.0 | 1.0 | 1.0 | 1.0 |
| 100 | 100 | 92 | 90 | 92 |
| 100 | 102 | 95 | 92 | 94 |

From the results in Tables 1 to 3, it is understood that the respective rubber compositions according to Examples 1 to 12 are excellent in workability and further respective vulcanized rubbers yielded from the compositions are excellent in low exothermicity.

What is claimed is:

1. A rubber composition, comprising one or more rubber components, and
an oil of a plant in the family Euphorbiaceae in an amount of 1 to 60 parts by mass for the entire amount of the rubber component(s) when the entire amount is regarded as 100 parts by mass.

2. The rubber composition according to claim 1, wherein the plant oil is an oil originating from an inedible resource and comprising an unsaturated fatty acid in a proportion of 50% by mass or more of the plant oil.

3. The rubber composition according to claim 1, comprising one or more softener components, and comprising the plant oil in a proportion of 10% by mass or more of the whole of the softener component(s).

4. The rubber composition according to claim 1, wherein the plant in the family Euphorbiaceae is at least one selected from the group consisting of Vernicia cordata, Aleurites fordii, Jatropha curcas, and Para rubber tree.

5. The rubber composition according to claim 1, comprising, as the rubber component(s), natural rubber in an amount of 5 to 100 parts by mass.
